(19) United States
(12) Patent Application Publication
(10) Pub. No.: US 2015/0046418 A1
(43) Pub. Date: Feb. 12, 2015

(54) PERSONALIZED CONTENT TAGGING

(71) Applicant: Microsoft Corporation, Redmond, WA (US)

(72) Inventors: Murat Akbacak, Burlingame, CA (US); Benoit Dumoulin, Palo Alto, CA (US)

(73) Assignee: Microsoft Corporation, Redmond, WA (US)

(21) Appl. No.: 13/963,443

(22) Filed: Aug. 9, 2013

(51) Int. Cl. G06F 17/30

(52) U.S. Cl. CPC G06F 17/30038; G06F 17/3002
USPC 707/706; 707/741

(57) ABSTRACT

One or more techniques and/or systems are provided for maintaining user tagged content. For example, a user may experience content (e.g., watch a scene of a movie, create a photo, create a social network post, read an email, etc.), which the user may desire to save and/or organize for later retrieval. Accordingly, a personalization tag for the content may be received from the user (e.g., “Paris vacation photo”). The content may be indexed with the personalization tag within a personalization index (e.g., a cloud-based index for the user that may be accessible to any device associated with the user). In this way, the user may retrieve the content at a later point in time from any device. For example, a search query “Paris photos” may be received from the user. The personalization index may be queried using the search query to identify content that may be provided to the user.

### BACKGROUND

Many users may discover, explore, and/or interact with content through various devices and/or applications. For example, a user may read emails through an email application, capture a photo on a mobile device, update a social network profile from a tablet device, visit various websites over a week in order to plan a vacation, etc. In this way, the user may experience content that the user may desire to save and/or organize for later retrieval. For example, the user may organize the photo into a photo album on the mobile device, the user may bookmark a vacation website through a web browser, and/or the user may perform other various actions to manually save and/or organize content. Unfortunately, such content may not be adequately retained and/or organized for later access from various devices associated with the user. For example, the user may be unable to remember the location of the photo album within the mobile device and/or the user may be unable to access the bookmark on a different device than the device from which the bookmark was created. The inability to save and/or recall content from any device may result in a diminished user experience.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for maintaining user tagged content are provided herein. For example, first content experienced by a user may be identified. It may be appreciated that content may correspond to any type of content (e.g., an email, a user created task, a video, an image, a document, a website, a video game level, a location on a map, a set of content associated with a vacation, a set of content associated with planning an event, and/or any other type of content that may be experienced by a user). A first personalization tag for the first content may be received from the user (e.g., “I just captured this photo of Mary and me on vacation in Paris” for a vacation photo). In an example, a tag suggestion (e.g., derived from a social network profile of the user, a search engine suggestion, a localized suggestion based upon how the user tagged other content, a global suggestion based upon how other users may tag such content, etc.) may be selected by the user as the first personalization tag. It may be appreciated that the first personalization tag may be received as a voice input, a textual input, and/or other type of input from the user. The first content may be indexed with the first personalization tag within a personalization index as a first index entry. For example, the first index entry may comprise the first content or a reference to the first content and/or may comprise a first lattice comprising one or more searchable strings derived from the personalization tag. In an example, the personalization index may be hosted by a cloud service on behalf of the user such that the user may tag content for inclusion within and/or later retrieval from the personalization index from any device. In this way, the user may be provided with access to content indexed within the personalization index.

In an example of providing access to content indexed within the personalization index, a search query may be received from the user (e.g., “I want to see my pictures of Paris”). The personalization index may be queried using the search query (e.g., a search lattice comprising one or more search strings derived from the search query) to identify a set of content corresponding to the search query. For example, the set of content may comprise the first content of the vacation photo, second content of a Paris social network page tagged by the user, third content of a document about photography tagged by the user, and/or other content corresponding to the search query. In an example, the set of content may comprise global content obtained from a global index (e.g., content tagged by users of a social network, content provided by a search engine based upon the search query, etc.). The set of content may be provided to the user. In this way, the user may save content in a personalized manner for later retrieval from any device.

In an example, a personal assistant service may be exposed to the user. The personal assistant service may evaluate content indexed within the personalization index and/or within the global index to determine a recommendation for the user. For example, the personal assistant service may determine that the user has tagged content associated with an upcoming concert. The personal assistant service may determine that tickets have become available for the concert, and thus may provide a recommendation to the user to order tickets. The recommendation may comprise access to a service, website, and/or app through which the user may perform a ticket order action (e.g., a ticket sales app may be provided and/or prepopulated with concert information for the user to efficiently complete the task of ordering concert tickets for the concert the user has tagged).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of maintaining user tagged content.

FIG. 2A is a component block diagram illustrating an exemplary system for facilitating user tagging of content.

FIG. 2B is a component block diagram illustrating an exemplary system for facilitating user tagging of content.

FIG. 2C is an illustration of an example of a user tagging a social network post.

FIG. 3 is a component block diagram illustrating an exemplary system for selectively providing content to a user based upon a search query.

FIG. 4 is a flow diagram illustrating an exemplary method of providing a recommendation to a user based upon content indexed within a personalization index.

FIG. 5 is a component block diagram illustrating an exemplary system for providing a recommendation to a user based upon content indexed within a personalization index.

FIG. 6 is an illustration of an exemplary computer readable medium wherein processor-executable instructions configured to embody one or more of the provisions set forth herein may be comprised.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

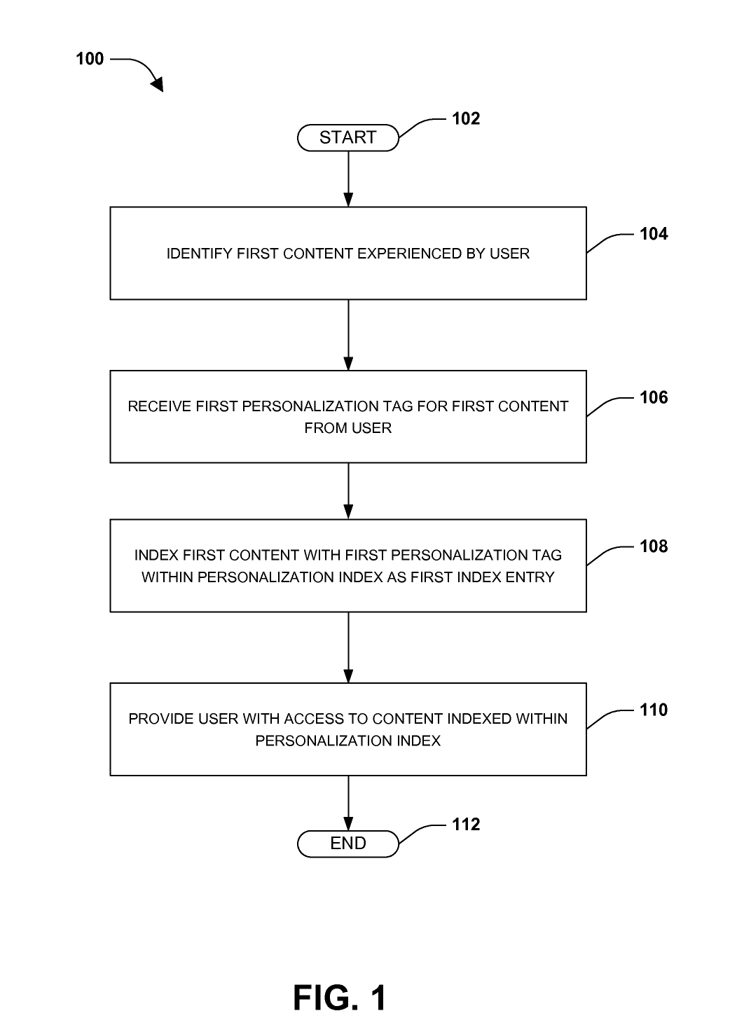

An embodiment of maintaining user tagged content is illustrated by an exemplary method 100 of FIG. 1. At 102, the method starts. A personalization index may be created and/or maintained for a user. Content may be tagged by the user for storage within and/or later retrieval from the personalization index. At 104, first content experienced by the user may be identified. In an example, a user may win a race while playing a racing video game on a gaming console device (e.g., the first content may correspond to video game footage of the race). In another example, a visual device, such as a smart glass device or a camera device, associated with the user (e.g., worn by the user) may visually identify a car used to win the race based upon visual imagery captured in response to a user input (e.g., the user may say “tag it” or other voice command, which maybe invoke the visual device to capture the imagery of the car as the first content). In another example, a peripheral device, such as a computer watch or game controller comprising image capture functionality, may identify the car based upon a gesture of the user (e.g., the user may point to a TV with the computer watch and/or may say “tag it” or other voice command).

At 106, a first personalization tag for the first content may be received from the user (e.g., “that was my best race in the Sports Car video game using the new Electric Car”). In an example, the first personalization tag may be received as voice input (e.g., a voice tag), textual input, and/or any other type of from the user. Because the first personalization tag may be received as voice input on a first device, but may be later used to query the first content as voice input on a second device, various cross-device acoustic mismatch compensation techniques may be implemented (e.g., cross-device usage recognition, noise compensation, acoustic mismatch compensation, device acoustic profiling functionality, and/or other techniques may be implemented to reduce cross-device mismatches, such as in terms of acoustics). In an example of voice input, a word-based speech recognizer and indexer and/or a sub-word recognizer and indexer (e.g., sub-word recognition such as syllables, graphones, N-gram of phones, phonetic sequences, etc.) may be used to recognize and/or index the first personalization tag, such as in a language independent manner. In another example, a tag suggestion may be selected by the user as the first personalization tag (e.g., a localized tag suggestion based upon one or more prior personalization tags indexed within the personalization index for the user; a global tag suggestion based upon a global index comprising tagging information associated with a plurality of users; a social network tag suggestion based upon a social network of the user; a search engine tag suggestion based upon a search engine evaluation of the first content; etc.).

At 108, the first content may be indexed with the first personalization tag within the personalization index as a first index entry. In an example, a first lattice (e.g., a word-based lattice and/or a phonetics lattice) comprising one or more searchable strings (e.g., “best race”, “Sports Car video game”, “video game”, “Electric Car”, etc.) derived from the personalization tag may be stored as part of the first index entry. In another example, first metadata describing the first content may be identified (e.g., a name of the video game, a name of the gaming console device, a snapshot of the race, a name of the race track, a current time, a user profile logged into the gaming console device, etc.). The first metadata may be stored as part of the first index entry. It may be appreciated that metadata may comprise any information related to content and/or a user, such as URL information, an action performed by a computing environment (e.g., loading a particular race track into memory for the race, creating a snapshot of a winning race screen, etc.), a reference to a portion of the first content experienced by the user (e.g., a video clip of the user crossing the finish line), application execution information associated with an application providing the first content (e.g., information about the racing game), a snapshot of the application (e.g., a snapshot of the Electric Car), a browser session information, computing environment session information, location information, temporal information, user experience information associated with the user experiencing the first content (e.g., visual and/or other feedback of the user participating in the race), etc. Metadata may be based upon automatic audio, image, and/or text processing that may capture document content, such as acoustic-based or image-based environment detection, face detection, etc.

It may be appreciated that the personalization index may be organized and/or updated in various manners. In an example, a first category for the first content may be identified based upon the first metadata (e.g., a racing game category). The first index entry may be organized within the personalization index based upon the first category. In another example, a category recommendation of a category for the first content may be provided to the user based upon metadata stored within the personalization index and/or category information within the global index (e.g., a video game category). Responsive to selection of the category recommendation, the first index entry may be organized within the personalization index based upon the category. In another example, one or more groups of related content, indexed within the personalization index, may be identified. The one or more groups of related content may be organized into a folder (e.g., a video game content folder within which tagged video game content, such as video game websites, video game trailers, video gameplay footage, and/or other content tagged by the user as video game related, may be stored). In another example, an unsupervised pattern discovery technique and/or a keyword/phrase discovery techniques may be used to evaluate content (e.g., one or more audio content files) to identify repeated keywords or phrases that may be used to augment a lattice, a tagging component, and/or a searching component (e.g., if a first audio content file and a second audio content file both comprise one or more instances of “Stan the man”, then “Stan the man” may be identified as a keyword or phrase having a probability of being used as a tag or query for the first audio content and/or the second audio content).

At 110, the user may be provided with access to content indexed within the personalization index. It may be appreciated that the user may access such content from any device, such as a second device (e.g., a tablet device). In an example, a search query may be received from the user (e.g., a voice query “I want to see my best racing game footage”). The personalization index may be queried using the search query to identify a set of content corresponding to the search query. For example, a search lattice may be created using the search query. The search lattice may comprise one or more search strings derived from the search query (e.g., “racing game”, “game footage”, “best racing”, etc.). The search lattice may be used to query one or more lattices associated with the content indexed with the personalization index to identify the set of content. In an example, a global index (e.g., social network data maintained by a social network, web content maintained by a search engine, a global repository of user tagged content, etc.) may be queried using the search query to identify global content for inclusion within the set of content (e.g., racing game footage of another user for the same racing video game). In another example, the set of content may be ranked based upon how relevant respective content within the set of content is to the search query (e.g., how closely respective lattices matched the search lattice). The set of content may be provided to the user. In an example, an action associated with first corresponding content within the set of content may be provided (e.g., a view video clip action by a video app, a preorder action for a sequel racing game by a shopping app, etc.). The action may be invokable by the user to perform a task associated with the first corresponding content. It may be appreciated that merely a sub-set of the personalization index may be searched to identify the set of content. For example, merely one or more categories of the personalization index that match the search lattice (e.g., to within a specified degree) may be searched (e.g., to mitigate using resources searching through potentially less relevant content). In an example, keywords within a personalization index may be discovered and/or used to build a statistical model that may be used to augment sub-word recognition with word or phrase models and/or for hybrid recognition and/or indexing strategies.

In an example, user feedback may be identified based upon how the user interacts or does not interact with the set of content. For example, responsive to a selection, by the user, of selected content from the set content, user feedback may be generated based upon the selection. The user feedback may indicate that a first weight, assigned to a first feature (e.g., a categorization, a search string within a lattice, etc.) used to identify the selected content for inclusion within the set of content, is to be increased. The user feedback may indicate that a second weight, assigned to a second feature (e.g., a categorization, a search string within a lattice, etc.) used to identify non-selected content for inclusion within the set of content, is to be decreased. In an example, user feedback may be used to improve indexing (e.g., used by a tagging component) and/or retrieval models (e.g., used by a searching component), such as to train a machine learning technique (e.g., an active learning technique). In this way, techniques and/or models used to select content from the personalization index may be trained and/or updated based upon the user feedback. At 112, the method ends.

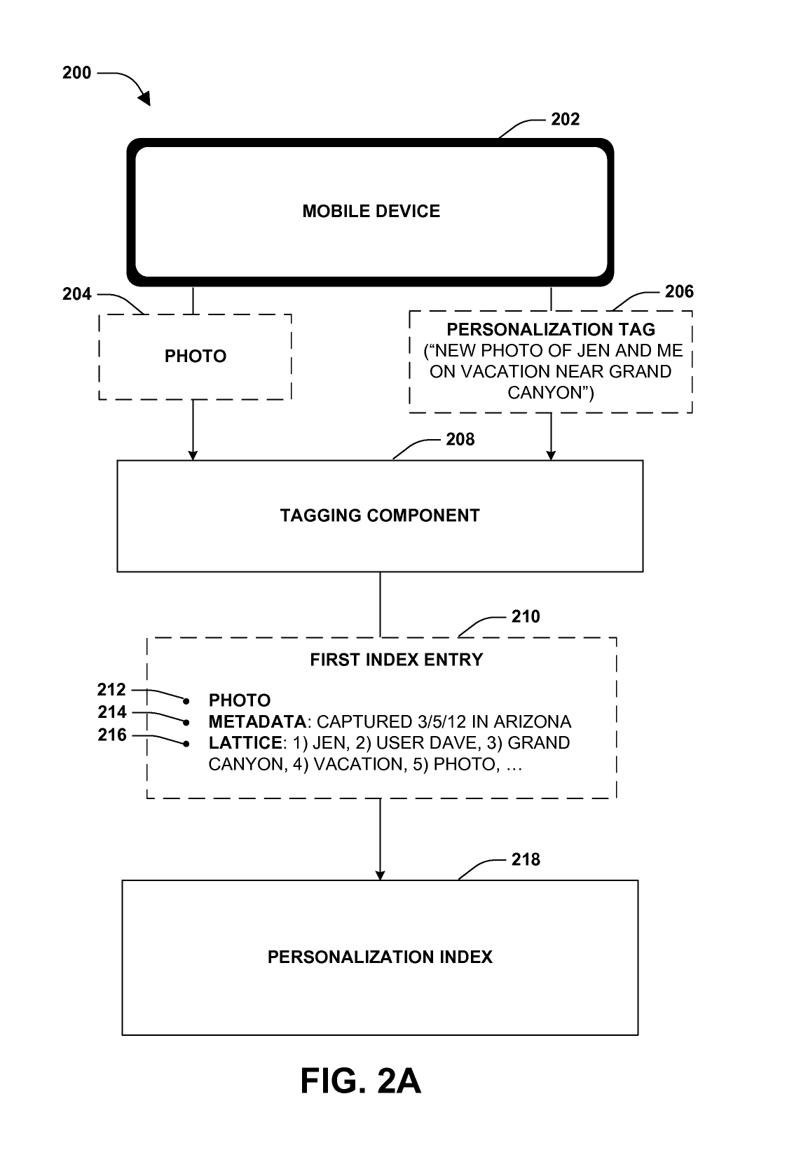

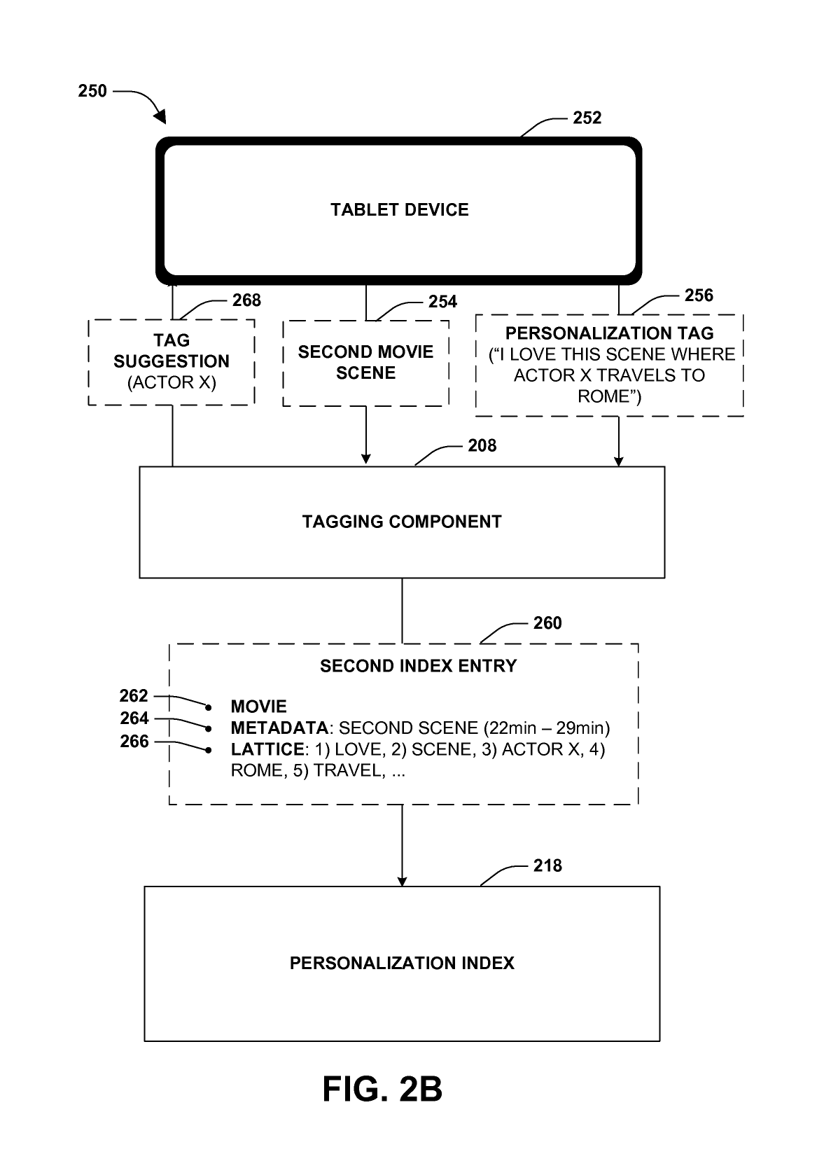

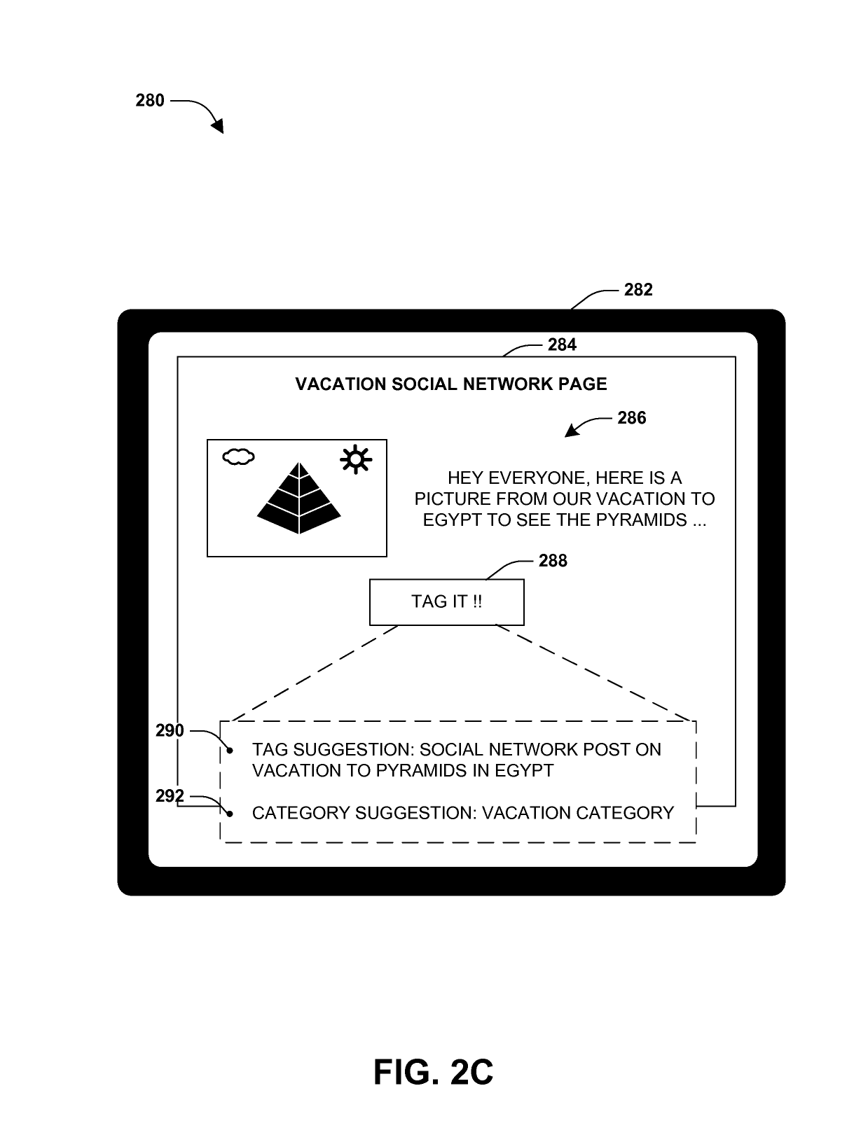

FIG. 2A illustrates an example of a system 200 for facilitating user tagging of content. The system 200 may comprise a tagging component 208. The tagging component 208 may be configured to identify first content experienced by a user, such as a photo 204 captured by a mobile device 202 of the user. The tagging component 208 may be configured to receive a personalization tag 206 for the photo 204 from the user. For example, the personalization tag 206 may comprise a voice tag “new photo of Jen and me on vacation near Grand Canyon”). The tagging component 208 may be configured to index the photo 204 with the first personalization tag 206 within a personalization index 218 associated with the user. For example, the tagging component 208 may create a first index entry 210 comprising the photo 204 (e.g., or a reference 212 to the photo), metadata 214 associated with the photo 204 (e.g., a capture date of Mar. 5, 2012 and a capture location of Arizona), and/or a lattice 216 comprising one or more searchable strings derived from the personalization tag 206 (e.g., “Jen”, “User Dave”, “Grand Canyon”, “vacation”, “photo”, etc.). In this way, the personalization index 218 may be populated with content tagged by the user in a personalized manner.

FIG. 2B illustrates an example of a system 250 for facilitating user tagging of content. The system 200 may comprise a tagging component 208. The tagging component 208 may be configured to identify second content experienced by a user, such as a second movie scene 254 displayed on a tablet device 252 of the user. Responsive to identifying the second movie scene 254, the tagging component 208 may provide a tag suggestion 268 of “actor X” based upon information within a global index (e.g., other users may have tagged the second movie scene 254 with “actor X”) and/or information from a search engine (e.g., the search engine may determine that an actor, actor X, portray a main character in the movie). In this way, the user may select the tag suggestion 268 as a personalization tag for tagging the second movie scene 254.

In an example, the tagging component 208 receives a personalization tag 256 for the second movie scene 254 from the user. For example, the personalization tag may comprise the tag suggestion 268 of “actor X” if endorsed (e.g., clicked on, etc.) by the user. In an example, the personalization tag 256 may comprise a textual tag “I love this scene where actor X travels to Rome”. The tagging component 208 may be configured to index the second movie scene 254 with the first personalization tag 256 within a personalization index 218 associated with the user. For example, the tagging component 208 may create a second index entry 260 comprising the second movie scene 254 (e.g., or a reference 262 to the movie scene), metadata 264 associated with the second movie scene 254 (e.g., an indication that the personalization tag 256 and/or the second movie scene 254 corresponds to minutes 22 through 29 of the movie), and/or a lattice 266 comprising one or more searchable strings derived from the personalization tag 256 (e.g., “love”, “scene”, “actor X”, “Rome”, “travel”, etc.). In this way, the personalization index 218 may be populated with content tagged by the user in a personalized manner. In an example, the user of the tablet device 252 may also be the user of the mobile device 202 of FIG. 2A, and thus the personalization index 218 comprises a first index entry 210 created based upon tagging activity of the user on the mobile device 202 and the second index entry 260 created based upon tagging activity of the user on the tablet device 252. In this way, the personalization index 218 may be maintained on behalf of the user by a cloud service that provides access to the personalization index 218 for tagging and/or content retrieval from any device. In an example, the personalization index 218 may be distributed across multiple devices (e.g., of the user). In an example, the personalization index 218 may be comprised within a particular device of the user. In an example, a local instance of the personalization index 218 may be synchronized with one or more non-local instances of the personalization index upon connection (e.g., via a network) of a user device comprising the local instance with one or more devices comprising the one or more non-local instances.

FIG. 2C illustrates an example 280 of a user tagging a social network post 286. A user of a computing device 282 may navigate to a vacation social network page 284 hosted by a social network. The user may experience the social network post 286 on the vacation social network page 284 (e.g., a vacation user may have posted the social network post 286, describing a vacation picture of Egypt, to the vacation social network page 284). The social network post 286, such as the vacation picture and the description of the vacation picture, may be identified as content experienced by the user. Accordingly, a tag it user interface element 288 may be provided to the user. The user may invoke the tag it user interface element 288 in order to select or create a personalization tag for tagging the social network post 286. In an example, a tag suggestion 290 of “social network post on vacation to pyramids in Egypt” may be provided to the user. In this way, the user may select the tag suggestion 290 as the personalization tag or may create a new personalization tag. In an example, a category suggestion 292 of a vacation category may be provided to the user. In this way, the user may select the category suggestion 292 for categorizing the social network post 286 (e.g., such that the personalization tag may be comprised and/or otherwise associated with a category corresponding to the category suggestion). In an example, the user may create such a category.

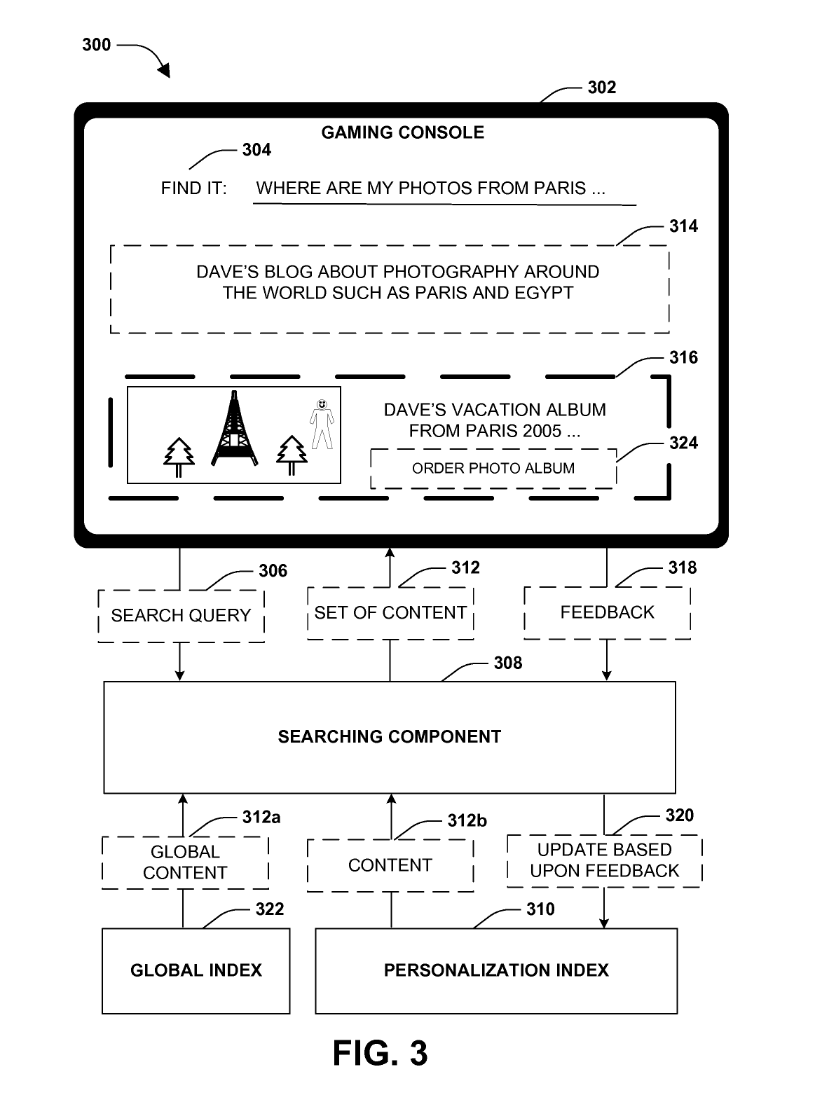

FIG. 3 illustrates an example of a system 300 for selectively providing content to a user based upon a search query 306. The system 300 may comprise a searching component 308 associated with a personalization index 310 maintained for a user. The personalization index 310 may comprise one or more index entries comprising content indexed using personalization tags provided by the user. In an example, the searching component 308 may be associated with a global index 322 comprising various information that may be used to provide tag suggestions, provide category suggestions, retrieve content relevant to the search query 306 (e.g., the global index 322 may comprise global content tagged by a plurality of users), and/or other information associated with a global segment of users (e.g., users of a social network, users of a search engine, users of a personal assistant service, etc.).

The searching component 308 may be configured to receive the search query 306 from the user. For example, the user may submit the search query 306 “where are my photos from Paris” through a find it user interface element 304 hosted by a gaming console 302. The searching component 308 may query the personalization index 310 using the search query 306 to identify content 312b corresponding to the search query 306. In an example, the searching component 308 may create a search lattice using the search query 306. The search lattice may comprise one or more search strings (e.g., “photos”, “Paris”, etc.) derived from the search query 306. The search lattice may be used to query one or more lattices associated with content indexed with the personalization index to identify the content 312b. In an example, the searching component 308 may query the global index 322 using the search query 306 (e.g., the search lattice) to identify global content 312a (e.g., content tagged by other users with tags corresponding to the search query 306 and/or the search lattice). In this way, the search component 308 may identify a set of content 312 (e.g., comprising the content 312b and/or the global content 312a) that may be relevant to the search query 306.

The searching component 308 may be configured to provide the set of content 312 to the user, such as through the gaming console 302. For example, a first corresponding content 314 (e.g., a blog written by the user, Dave, about photographs around the world, such as Paris and Egypt), a second corresponding content 316 (e.g., a vacation album, by Dave, from a Paris 2005 vacation), and/or other corresponding content may be provided to the user. In an example, an action, such as a task completion action associated with corresponding content provided to the user, may be exposed to the user. The action may be invokable by the user to perform a task associated with corresponding content. For example, an order photo album action 324 may be exposed to the user, such that the user may invoke the order photo album action 324 to purchase a hardcover version of the vacation album from a photo service (e.g., the user may be directed to a photo service website or the user may be provided with a photo ordering app).

User feedback 318 may be generated based upon how the user views and/or interacts with the set of content 312. For example, the user may select the second corresponding content 316 in order to view photos from the vacation album. Accordingly, the user feedback 318 may indicate that a first weight, assigned to a first feature (e.g., a categorization, a search string within a lattice, etc.) used to identify the second corresponding content 316 for inclusion within the set of content 312, may be increased (e.g., based upon an assumption that the user found the second corresponding content 316 relevant due to the user interaction with the vacation album). The user feedback 318 may indicate that a second weight, assigned to a second feature (e.g., a categorization, a search string within a lattice, etc.) used to identify the first corresponding content 314 for inclusion within the set of content 312, may be decreased (e.g., based upon an assumption that the user did not find the first corresponding content 314 relevant due to a lack of user interaction with the blog authored by Dave). In this way, the personalization index 310 and/or one or more search models used to identify corresponding content may be updated 320 based upon the feedback 318.

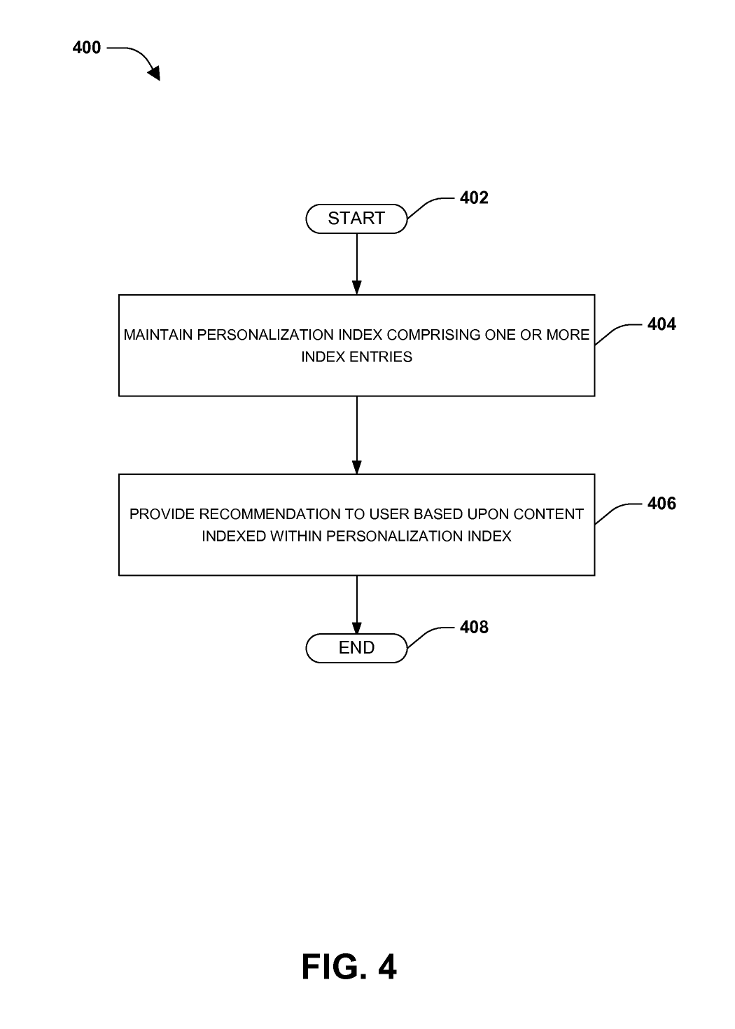

An embodiment of providing a recommendation to a user based upon content indexed within a personalization index is illustrated by an exemplary method 400 of FIG. 4. At 402, the method starts. At 404, a personalization index comprising one or more index entries may be maintained (e.g., on behalf of a first user). For example, a first index entry comprises first content indexed by a first personalization tag used by the first user to tag the first content (e.g., the first content, corresponding to a watch repair location on a map, may have been tagged with a personalization tag of “This looks like a good place to get my watch fixed”). In this way, content, tagged by the first user, may be organized into the personalization index for later retrieval by the first user.

At 406, a recommendation may be provided, such as by a personal assistant, to the user based upon the content indexed within the personalization index. For example, the first content may indicate a user task of watch repair, which may be used to provide a watch repair recommendation to the user. The recommendation may be derived from temporal information (e.g., a current time may indicate that the watch repair location is open for business), location information (e.g., a current location of the user may be relatively close to the watch repair location), activity information (e.g., the user may be driving a car to a destination along a route that includes the watch repair location), etc. In an example, a global index or other source may be consulted to generate and/or tailor the recommendation (e.g., if the watch repair location has a relatively low rating from users, then an alternate watch repair location may be recommended). In this way, recommendations may be provided to the user, which may facilitate task completion, for example. At 408, the method ends.

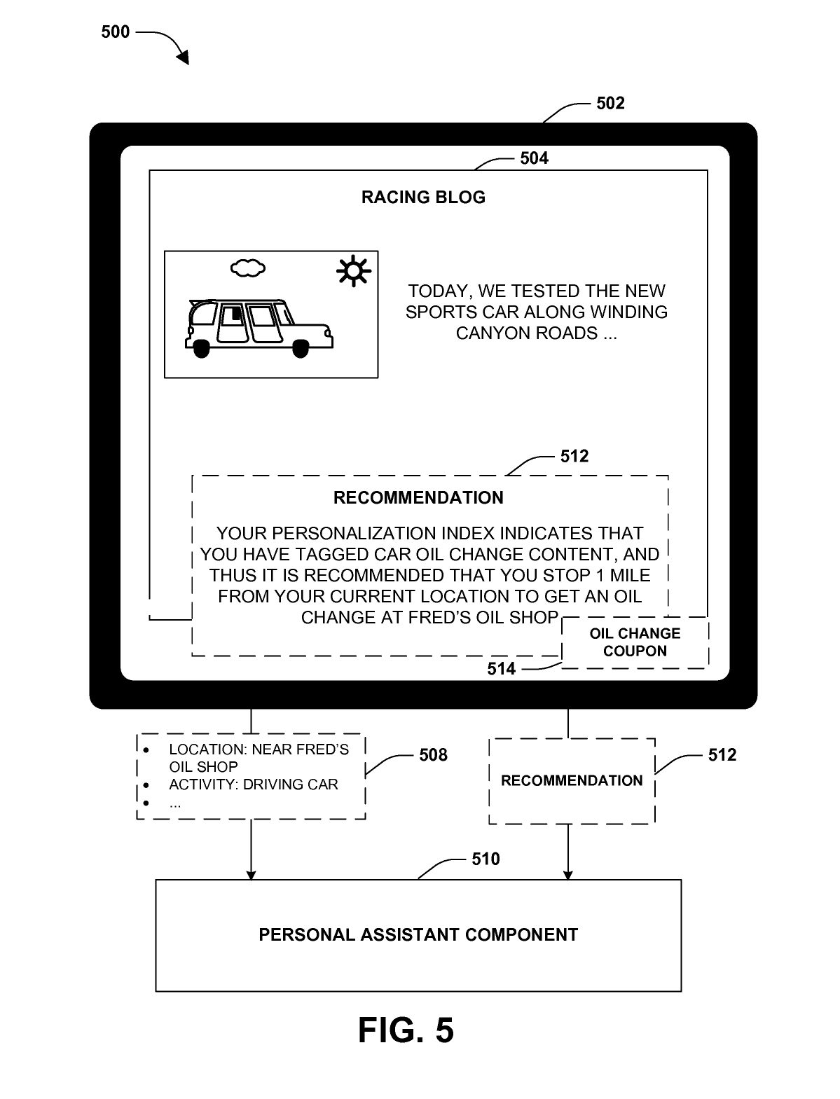

FIG. 5 illustrates an example of a system 500 for providing a recommendation 512 to a user based upon content indexed within a personalization index. The system 500 may comprise a personal assistant component 510. The personal assistant component 510 may be associated with a computing device 502 of the user (e.g., the user may be currently viewing a racing blog 504 using the computing device 502). The personal assistant component 510 may be configured to identify various information 508 about the user and/or the computing device 502, such as a current location of the user (e.g., the user may be relatively close to Fred's oil shop), an activity of the user (e.g., the user may be driving a car), and/or a variety of other information (e.g., temporal information indicating Fred's oil shop may be currently open for business). The personal assistant component 510 may be configured to consult the personalization index (e.g., the user may have tagged car oil change content, such as a calendar entry to get an oil change) and/or a global index (e.g., users may have rated Fred's oil shop with a relatively high user rating) in order to generate the recommendation 512. Accordingly, the personal assistant component 510 may be configured to generate the recommendation 512 based upon information within the personalization index and/or the global index. For example, the recommendation 512 may specify that the user should stop 1 mile from the user's current location to get an oil change at Fred's oil shop. In an example, an oil change coupon (e.g., obtained from a search engine, a website, a coupon app, the global index, etc.) may be provided with the recommendation 512. In this way, the personal assistant component 510 may provide recommendations to the user, which may facilitate task completion, for example.

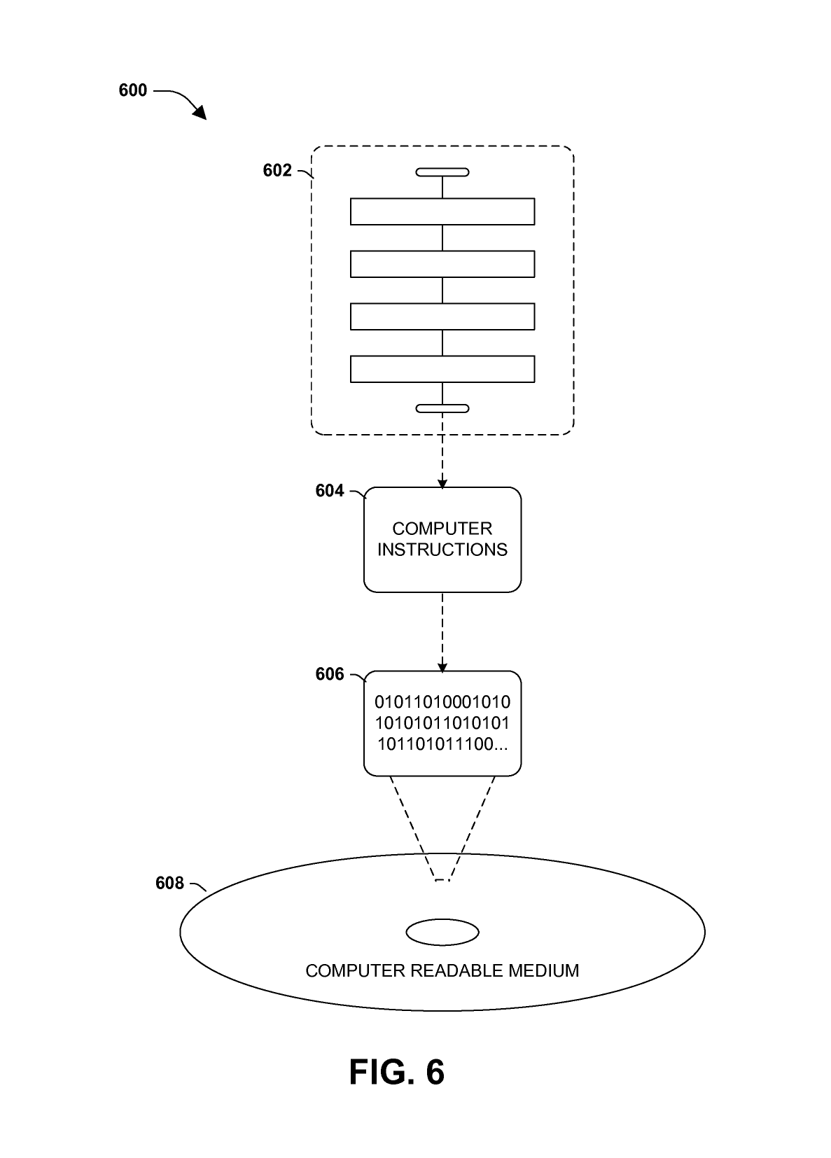

Still another embodiment involves a computer-readable medium comprising processor-executable instructions configured to implement one or more of the techniques presented herein. An example embodiment of a computer-readable medium or a computer-readable device is illustrated in FIG. 6, wherein the implementation 600 comprises a computer-readable medium 608, such as a CD-R, DVD-R, flash drive, a platter of a hard disk drive, etc., on which is encoded computer-readable data 606. This computer-readable data 606, such as binary data comprising at least one of a zero or a one, in turn comprises a set of computer instructions 604 configured to operate according to one or more of the principles set forth herein. In some embodiments, the processor-executable computer instructions 604 are configured to perform a method 602, such as at least some of the exemplary method 100 of FIG. 1 and/or at least some of the exemplary method 400 of FIG. 4, for example. In some embodiments, the processor-executable instructions 604 are configured to implement a system, such as at least some of the exemplary system 200 of FIG. 2A, at least some of the exemplary system 250 of FIG. 2B, at least some of the exemplary system 300 of FIG. 3, and/or at least some of the exemplary system 500 of FIG. 5, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

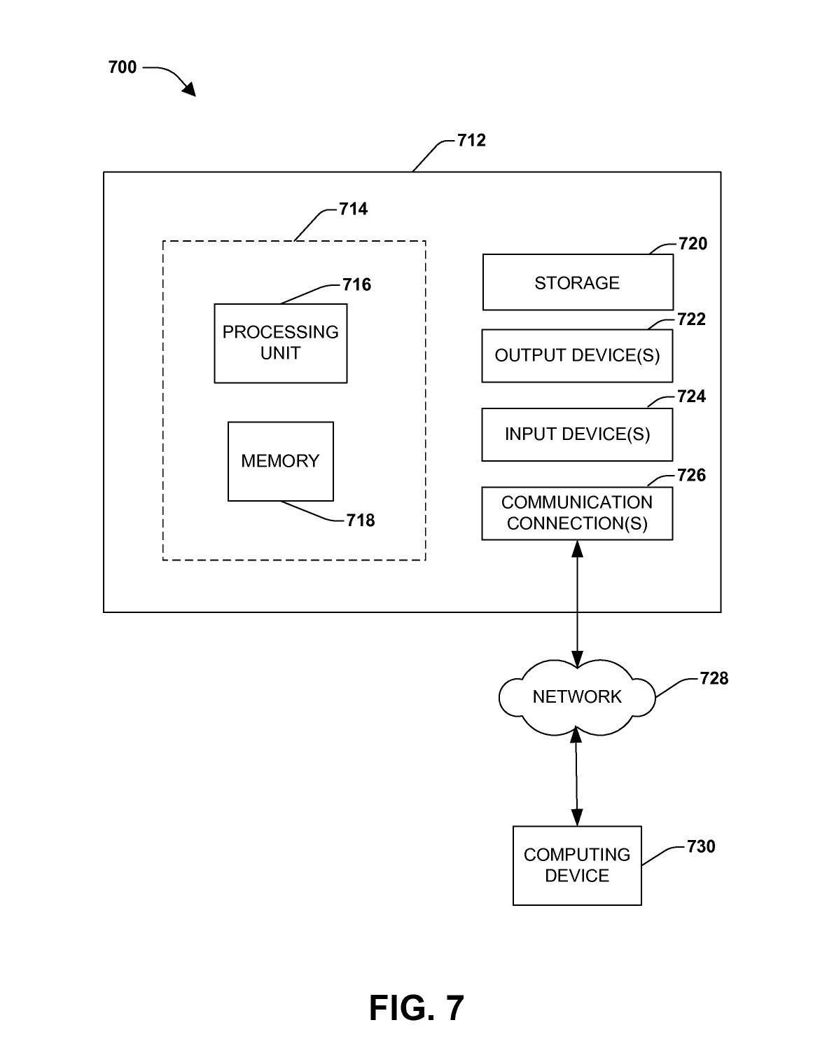

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 700 comprising a computing device 712 configured to implement one or more embodiments provided herein. In one configuration, computing device 712 includes at least one processing unit 716 and memory 717. Depending on the exact configuration and type of computing device, memory 717 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 717 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 717 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 717 may be comprised of multiple physical memory units located in different physical locations interconnected by a network.

Those skilled in the art will realize that storage devices utilized to store computer readable instructions may be distributed across a network. For example, a computing device 730 accessible via a network 727 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for maintaining user tagged content, comprising:
identifying first content experienced by a user;
receiving a first personalization tag for the first content from the user;
indexing the first content with the first personalization tag within a personalization index as a first index entry; and
providing the user with access to content indexed within personalization index.

2. The method of claim 1, the receiving a first personalization tag comprising at least one:
presenting a localized tag suggestion for selection as the first personalization tag based upon one or more prior personalization tags, of the user, indexed within the personalization index;
presenting a global tag suggestion for selection as the first personalization tag based upon a global index comprising tagging information associated with a plurality of users;
presenting a social network tag suggestion for selection as the first personalization tag based upon a social network of the user; or
presenting a search engine tag suggestion for selection as the first personalization tag based upon a search engine evaluation of the first content.

3. The method of claim 1, the first content experienced by the user on a first device, and the providing the user with access comprising:
providing the user with access to the first content on a second device.

4. The method of claim 1, the indexing the first content with the first personalization tag comprising:
storing a first lattice comprising one or more searchable strings derived from the personalization tag as part of the first index entry.

5. The method of claim 1, the indexing the first content with the first personalization tag comprising:
identifying first metadata describing the first content; and
storing the first metadata as part of the first index entry.

6. The method of claim 5, the first metadata comprising at least one of URL information, an action performed by a computing environment before the indexing, a reference to a portion of the first content experienced by the user, application execution information associated with an application providing the first content, a snapshot of the application, browser session information, computing environment session information, location information, temporal information, or user experience information associated with the user experiencing the first content.

7. The method of claim 5, comprising:
identifying a first category for the first content based upon the first metadata; and
organizing the first index entry within the personalization index based upon the first category.

8. The method of claim 1, comprising:
providing a first category recommendation of a first category for the first content based upon at least one of metadata stored within the personalization index or category information within a global index; and
responsive to selection of the first category recommendation, organizing the first index entry within the personalization index based upon the first category.

9. The method of claim 1, the receiving a first personalization tag comprising receiving a voice tag from the user.

10. The method of claim 1, the providing the user with access comprising:
receiving a search query from the user;
querying the personalization index using the search query to identify a set of content corresponding to the search query; and
providing the set of content to the user.

11. The method of claim 10, the querying comprising:
creating a search lattice using the search query, the search lattice comprising one or more search strings derived from the search query; and
using the search lattice to query one or more lattices associated with the content indexed within the personalization index to identify the set of content.

12. The method of claim 10, comprising:
querying a global index using the search query to identify global content for inclusion within the set of content.

13. The method of claim 10, comprising:
responsive to an indication of a selection, by the user, of selected content from the set of content, generating user feedback based upon the selection, the user feedback indicating that a first weight assigned to a first feature used to identify the selected content for inclusion within the set of content is to be increased, the user feedback indicating that a second weight assigned to a second feature used to identify non-selected content for inclusion within the set of content is to be decreased.

14. The method of claim 10, the providing the set of content comprising:
providing first corresponding content that corresponds to the search query and an action associated with the first corresponding content, the action invokable by the user to perform a task associated with the first corresponding content.

15. The method of claim 1, comprising:
exposing a personal assistant service to the user; and
providing, via the personal assistant, a recommendation to the user based upon the content indexed within the personalization index, the recommendation derived from at least one of temporal information, location information, or activity information identified from the content.

16. The method of claim 1, comprising:
identifying one or more groups of related content indexed within the personalization index; and
organizing the one or more groups of related content into one or more folders.

17. A system for maintaining user tagged content, comprising:
a tagging component configured to:
maintain a personalization index comprising one or more index entries, a first index entry comprising first content and a first personalization tag used by a user to tag the first content; and
a searching component configured to:
receive a search query from the user;
query the personalization index using the search query to identify a set of content corresponding to the search query; and
provide the set of content to the user.

18. The system of claim 17, the tagging component configured to maintain the personalization index with a cloud service accessible to a plurality of client devices associated with the user.

19. The system of claim 17, comprising:
a personal assistant component configured to:
provide a recommendation to the user based upon the content indexed within the personalization index, the recommendation derived from at least one of temporal information, location information, or activity information identified from the content.

20. A method for maintaining user tagged content, comprising:
maintaining a personalization index comprising one or more index entries, a first index entry comprising first content and a first personalization tag used by a user to tag the first content; and
providing a recommendation to the user based upon the content indexed within the personalization index, the recommendation derived from at least one of temporal information, location information, or activity information.
